(19) United States
(12) Patent Application Publication
(10) Pub. No.: US 2026/0077666 A1
(43) Pub. Date: Mar. 19, 2026

(54) PLUG CONNECTOR PART FOR MECHANICAL AND ELECTRICAL CONNECTION TO A MATING PLUG CONNECTOR PART

(71) Applicant: Kiekert Aktiengesellschaft, Heiligenhaus (DE)

(72) Inventors: Robert LANDSKRON, Monheim (DE); Ingo NÖVERMANN, Mülheim an der Ruhr (DE); Michael BERRES, Köln (DE)

(73) Assignee: Kiekert Aktiengesellschaft, Heiligenhaus (DE)

(21) Appl. No.: 19/110,550

(22) PCT Filed: Sep. 11, 2023
(86) PCT No.: PCT/DE2023/100670

§ 371 Date: Mar. 11, 2025

(30) Foreign Application Priority Data
Sep. 23, 2022 (DE) 10 2022 124 509.8

(51) Int. Cl. B60L 53/302; B60L 53/16; H01R 13/533

(52) U.S. Cl. CPC B60L 53/302; B60L 53/16; H01R 13/533; H01R 2201/26

(57) ABSTRACT

The invention relates to a plug connector part for mechanical and electrical connection to a mating plug connector part, in particular a motor-vehicle-side charging socket (1) for coupling to a charging plug as components of an electrical charging infrastructure for electric or hybrid motor vehicles, or vice versa. To this end, a housing (2, 3) and at least one electrical contact element (4) located in the housing (2, 3) are provided. Moreover, a passively cooled heat conductor (7) is provided, one end (7a) of which is connected to the contact element (4) and the other end (7b) of which has a heat sink (8). According to the invention, the heat conductor (7) extends through a housing opening (2a, 3a) and is equipped outside the housing (2, 3) with the heat sink (8) arranged there.

The invention relates to a plug connector part for mechanical and electrical connection to a mating plug connector part, in particular a motor-vehicle-side charging socket for coupling to a charging plug as components of an electrical charging infrastructure for electric or hybrid motor vehicles, or vice versa, comprising a housing made of plastics material and at least one electrical contact element arranged in the housing, and comprising a preferably passively cooled heat conductor, one end of which is connected to the contact element and the other end of which has a heat sink.

The plug connector part is generally a charging socket in a motor vehicle that can be coupled with an associated charging plug-for example, on an electrical charging station. During the coupling process, an electrical and simultaneously mechanical connection is achieved and brought about between the charging socket and the charging plug. The charging plug, like the charging socket, is in this case part of the electrical charging infrastructure used to charge the rechargeable energy storage units or accumulators of electric or hybrid motor vehicles. In principle, the plug connector part on the motor vehicle can also be a charging plug instead of a charging socket. In this case, the charging station is equipped with an associated charging socket. As a rule, however, the electric or hybrid motor vehicle has the charging socket with a plurality of electrical contact elements, located in the housing, into which the charging plug connected to the charging station is inserted to charge the motor vehicle in question.

In order to be able to supply the high electrical performance of the electric motors in the motor vehicle in question with the necessary electrical energy on the one hand and to provide a sufficient range on the other, high-voltage batteries or accumulators are used nowadays, which are typically charged with high-voltage direct current. In addition to such DC (direct current) charging processes, most electric or hybrid motor vehicles also allow the charging process to be carried out via an alternating voltage in the sense of an AC (alternate current) charging process. At this point, however, low currents and long charging times are usually used, whereas, in the DC charging process described above, high voltages and high currents and the resulting short charging times are observed. In particular with DC charging processes, the fundamental problem is that the electrical contact elements used at this point become increasingly hot due to the high current intensity of up to several tens of amperes or more. This increases their resistance, which hinders the electrical charging process and the desired fast charging.

For this reason, the prior art according to EP 3 446 372 B1 already works with a heat conductor which is connected at its first end to a metal connection piece. In addition, a heat sink is provided which serves to dissipate heat from the at least one contact element.

However, the previously known teaching is aimed at the design of a charging plug and not a charging socket. In any case, the heat loss at the electrical contact element can only be inadequately dissipated via the heat sink arranged in the housing via the heat conductor to the heat sink. This can be attributed, among other things, to the fact that the housing of the charging plug is completely closed, because such charging plugs are installed as components of the charging infrastructure in the region of electrical charging stations, which in turn are generally exposed to the weather and especially rain without protection.

In the further prior art according to DE 20 2019 102 461 U1 or DE 10 2015 013 296 A1, there are already approaches to intensify cooling with a fan. However, this does not change the fundamental problem of heat dissipation from the housing.

The previously known teachings according to EP 4 000 989 A1 and EP 4 000 992 A1 face similar problems. In this case, too, the heat sink is located inside the housing, and due to the housing, heat build-up may even be observed at this point depending on the heat loss that occurs.

The invention is based on the technical problem of further developing a plug connector part of this kind in such a manner that the heat dissipation is improved compared to the prior art.

To solve this technical problem, the invention proposes, in a generic plug connector part for mechanical and electrical connection to a mating plug connector part, that the heat conductor passes through a housing opening and is equipped outside the housing, i.e., in an external region, with the at least one heat sink arranged there.

The invention therefore initially relies on at least one particularly passively cooled heat conductor or a “heatpipe” used at this point. This heat conductor in the form of a preferably metal pipe is now connected at one end to the electrical contact element in a heat-conducting manner. At the other end, the heat sink is provided so that, on the whole, a thermally conductive connection is available from the electrical contact element via the heat conductor to the heat sink. For this purpose, the heat sink is also connected in a heat-conducting manner to the heat conductor or the metal pipe provided at this point.

Advantageously, the at least one heat sink comprises a metal with good thermal conductivity, in particular aluminum and/or copper, or a ceramic material, in particular aluminum oxide and/or aluminum nitride. Particularly advantageously, the heat sink has a plurality of fins, in particular made of copper or aluminum.

Of particular inventive importance is the further circumstance that the at least one heat conductor passes through a housing opening, i.e., is led outside the housing. The heat sink is located or attached in this external region. As a result, heat generated on or in the electrical contact element can be dissipated particularly effectively via the heat conductor to the heat sink, which in turn is arranged outside the housing and can therefore dissipate the heat generated particularly effectively via convection.

The invention is based on the knowledge that such plug connector parts in the form of a charging socket are typically installed in the region of a body opening on or in a motor vehicle. The body opening can be found, for example, in a front or rear fender, above or even in a wheel arch. At this point, there is generally not only enough installation space for the plug connector part or the charging socket, but it is also ensured that the heat sink provided outside the housing can easily communicate with the ambient air, for example. At the same time, the heat sink is also protected from rain or stone chips because it is usually found in the wheel arch behind a wheel cover. In any case, this provides a particularly intensive heat dissipation and phenomena such as a possible heat build-up due to a closed housing, as in the prior art, can be avoided from the outset and due to the design. These are the main advantages.

It is further conceivable that a plurality of heat conductors (i.e., more than one), preferably between 2 and 5 heat conductors, connect the contact element to the heat sink at least in a heat-conducting manner.

In accordance with a further advantageous embodiment, the at least one heat conductor has electrical insulation at least in the external region and opposite the heat sink provided there. In most cases, the electrical insulation extends through the housing opening into the interior of the housing. The invention is based on the knowledge that the heat conductor, as already explained, is preferably a metal pipe. The metal pipe can, for example, also enclose a hermetically sealed volume. The volume is in turn filled with a working medium for heat transport, for example water.

In this way, the heat conductor or the metal pipe works according to the so-called wick principle. This means that the working medium provided inside the volume is, for example, evaporated in the region of the electrical contact element and condensed in the region of the heat sink. The wick principle is based on the fact that the condensed working medium is led back to the evaporator.

In any case, heat is transported overall from the electrical contact element as the heat source via at least one, preferably passively cooled heat conductor (heatpipe) to the heat sink as dissipator. Since the electrical contact element as well as the heat sink are preferably made of metal and the heat conductor is advantageously the metal pipe already described, electrical insulation of the heat sink and the region of the heat conductor in the external region, i.e., outside the housing, is required. This is ensured by the electrical insulation in the external region and in relation to the heat sink provided there. This means that the heat sink is electrically insulated from the heat conductor by means of the insulation. For this purpose, the electrical insulation extends through the housing opening into the interior of the housing, so that neither the heat sink nor the heat conductor in the external region carry any voltage or current. Electrical insulation can be a plastics coating on the metal pipe in the desired region. In principle, however, the electrical insulation can also be designed as a shrink tube or other plastics covering for the metal pipe.

The electrical insulation in the region of the housing opening may also act as a seal for the housing opening. In principle, however, an additional seal can also be provided in the region of the housing opening.

In order to further intensify the cooling effect and thus the heat transport from the electrical contact element via the heat conductor to the heat sink, the heat sink can be equipped with at least one additional cooling means. Then an active cooling of the heat conductor takes place. The cooling means is usually at least one electrically driven fan. This allows the cooling effect of the heat sink to be further increased through convection. For this purpose, at least one fan may be controlled by a control unit, at least during the electrical charging process. In principle, the cooling means, especially the fan, can also be operated for a certain period of time after the charging process has ended in order to cool down the heat sink if necessary. A fan according to the invention can preferably be designed as an axial or radial fan. In addition, it is conceivable that two or more fans are provided. It is also conceivable that fans of different dimensions or designs (axial or radial fans) are provided. In particular, if the heat sink has a plurality or multiplicity of fins, it is particularly preferred that the at least one fan is arranged on the heat sink in such a way that the fins are surrounded by the generated air flow, so that the cooling performance can be further increased. Furthermore, it is conceivable that the fan is at least partially integrated in the heat sink.

Particularly preferably, the fan and/or the control unit can be connected to at least one sensor for monitoring the temperature and/or the fan speed and/or the air flow of the fan. The control unit is designed in particular in such a way that the fan can be controlled by way of open-loop and/or closed-loop control depending on the temperature. In addition, the fan speed can be adjusted accordingly. This can particularly improve acoustic comfort.

Furthermore, it is conceivable that the fan has at least one damping means to reduce vibration. In particular, the fan can be attached to the heat sink with decoupler pins, for example. This avoids direct contact between the fan or fan housing and the, in particular metal, heat sink. Alternatively or additionally, a support frame for the fan can be provided, which is arranged between the fan and the heat sink and also avoids direct contact between the fan and the heat sink. The support frame or the decoupler pins are preferably made of rubber or at least comprise rubber.

As already described in the introduction, the preferably passively cooled heat conductor is connected at one end to the contact element. This is usually done by inserting the heat conductor into the contact element by the one end in question. In this case, specifically an embodiment has proven to be advantageous in which the heat conductor runs predominantly perpendicular to the longitudinal extent of the contact element.

This means that the heat conductor or the metal pipe provided at this point regularly extends perpendicular to the longitudinal extension of the contact element and consequently also to a plug-in direction of the mating plug connector part, with which the mating plug connector part is electrically and mechanically connected to the plug connector part. As a result, the heat sink provided outside the housing of the plug connector part can be easily placed above or below the housing and can communicate there with the ambient air during an electrical charging process of the motor vehicle, as already described in the introduction.

In this context, it is advantageous to proceed in such a way that the heat conductor is immersed in an arc shape into an upper opening of a connection piece of the contact element. This means that the arrangement of the heat conductor predominantly perpendicular to the longitudinal extension of the contact element requires a curved guidance of the heat conductor for the heat-conducting connection to the electrical contact element, namely in such a way that the heat conductor dips in an arcuate manner into the upper opening of the connection piece.

In principle, however, the heat conductor can also dip straight or predominantly straight into the top opening in question of the connection piece and in this way establish the desired heat-conducting connection to the connection piece and thus the contact element.

In both cases, the connection piece is electrically and thermally connected to the contact element. For this purpose, the connection piece can be coupled to the contact element, for example, by a plug connection or in some other way. A one-piece design of the connection piece on the one hand and the contact element on the other is also possible.

The upper opening in the connection piece is typically a half-cylinder opening if the heat conductor in this region is arcuate. This is because the connection piece, like the contact element, is generally cylindrical. In the event that the heat conductor is connected in a predominantly straight manner to the connection piece, the upper opening in the connection piece is typically designed as a cylindrical bore.

In either case, the heat conductor is first received in a hollow bore in the connection piece of the contact element and held therein and then leaves the connection piece in question via the curve or in a predominantly straight manner via the upper opening of the connection piece in order to then be able to transition into the predominantly perpendicular course in comparison to the longitudinal extension of the contact element or to maintain this perpendicular course. This provides and achieves a particularly favorable heat conductor because the heat conductor is immersed with one end in the associated hollow bore in the connection piece and the connection piece with the hollow bore encloses said end of the heat conductor.

Here, intimate thermal contact occurs between the connection piece and the heat conductor. In addition, since the connection piece is electrically and heat-conductively connected to the contact element, any heat loss generated at the contact element is transferred particularly effectively to the heat conductor, which in turn transports the resulting heat to the heat sink.

Since the electrical insulation already mentioned is usually provided at this point between the other end of the heat conductor and the heat sink, it is important to use an electrical insulation that is electrically insulating but at the same time heat-conducting. Thermoplastics which are designed as plastics injection-molded parts or are suitable for overmolding the metal pipe in the relevant region have proven to be advantageous here. Thermoplastics of this sort such as PP (polypropylene), PA (polyamide), PBT (polybutylene terephthalate), PE (polyethylene), etc. typically have thermal conductivities which, for polypropylene (PP), are for example 0.23 W/(m×K), or even up to 0.35 W/(m×K) for polyamides. Values of approximately 0.5 W/(m×K) are observed in conjunction with polyethylene (PE).

In order to increase thermal conductivity while still maintaining electrical insulation, the plastics mentioned above can also be equipped with embedded fillers. In this context, fillers that are electrically insulating and at the same time thermally conductive have proven to be particularly advantageous. They include, for example, aluminum compounds or boron compounds, particularly preferably aluminum oxide or boron nitride. This can yield increases in the thermal conductivity of the plastics material in question by at least a factor of 3.

As a result, a plug connector part for mechanical and electrical connection with a mating plug connector part is provided and realized, which has a significantly improved heat transport compared to the prior art. This can substantially be attributed to the fact that the heat sink has been placed on the heat conductor outside a housing, preferably made of plastics material, so that a particularly effective convection with, for example, ambient air is observed at this point. These are the main advantages.

The invention is explained in greater detail below with reference to drawings which show only one exemplary embodiment. In the drawings:

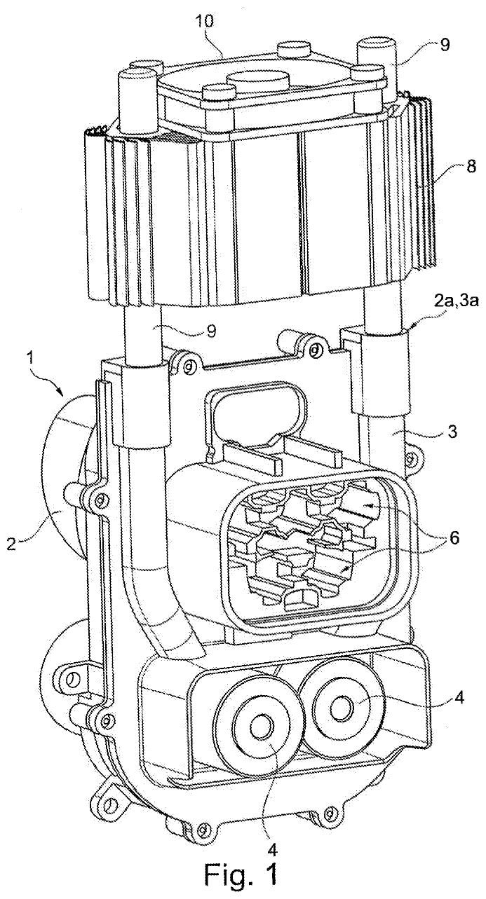

FIG. 1 shows the plug connector part according to the invention in a perspective rear view.

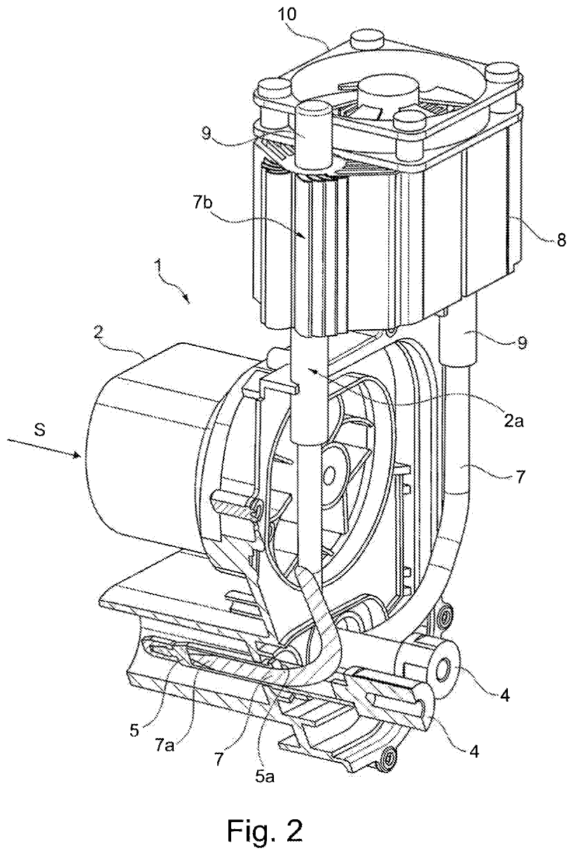

FIG. 2 shows the plug connector part according to FIG. 1 partially broken open in a perspective side view.

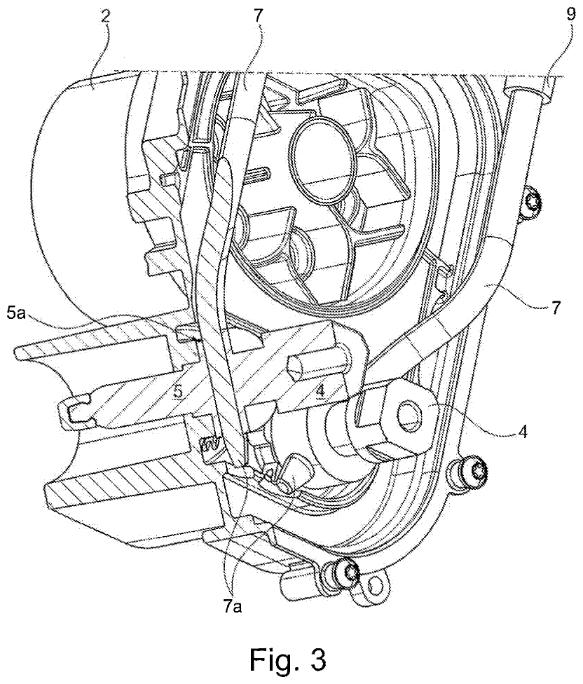

FIG. 3 shows a modified embodiment comparable to FIG. 2.

The figures show a plug connector part for mechanical and electrical connection with a mating plug connector part. In fact, the plug connector part in the context of the exemplary embodiment in FIGS. 1 and 2 is a motor-vehicle-side charging socket 1. The charging socket 1 is designed to be coupled with a charging plug, which is not shown in detail. The charging plug and the charging socket 1 each represent a component of an electrical charging infrastructure for electric or hybrid motor vehicles. For this purpose, the charging plug (not shown) is inserted into the charging socket 1 in the direction of the arrow S indicated in FIG. 2, which represents the plugging direction S relevant at this point for connecting the charging socket 1 and the charging plug.

The charging socket 1 is equipped with a housing 2, 3, which is composed of a front cover 2 and a rearward covering or rear cover 3 that can be connected thereto, which can be seen in particular in the rear view according to FIG. 1. In the housing 2, 3, a plurality of electrical contact elements 4 are then arranged and provided, which are contact elements 4 for a DC charging process. For this purpose, the electrical contact elements 4 are each electrically and thermally coupled to a connection piece 5, which can be understood in particular from the illustration in FIG. 2. The respective electrical contact elements 4 and the connection piece 5 can in principle also be formed in one piece, but in any case according to the exemplary embodiment—as described—they are electrically and thermally coupled to one another.

In addition to the electrical contact elements 4 for the DC charging process already mentioned, additional contact elements 6 are also implemented, which are required for an AC charging process, but are not relevant for the subsequent considerations. Rather, the electrical contact elements 4 are considered for the DC charging process because this is accompanied by a high electrical current.

Additionally and essentially, a passively cooled heat conductor 7 is also realized, which according to the exemplary embodiment is a “heatpipe” or a metal pipe as already described at the outset, which preferably has the already described hermetically coupled volume inside and a working medium for the heat transport therein. For this purpose, the metal pipe or heat conductor 7 has a defined length and is closed at both ends. For heat transport, the relevant heat conductor 7 is thermally coupled at one end 7a to the contact element 4 or the connection piece 5. The other end 7b of the passively cooled heat conductor 7 forms a thermal coupling with a heat sink 8, as can best be understood from FIG. 2. According to the exemplary embodiment, two electrical contact elements 4 are realized (DC charging process), which are each thermally coupled to the one common heat sink 8 via associated and likewise two heat conductors 7. This provides a thermally conductive connection from the relevant electrical contact element 4 or the associated connection piece 5 via the passively cooled heat conductor 7 to the heat sink 8.

Of particular importance now is the fact that, according to the invention, the heat conductor 7 passes through a housing opening 2a, 3a. In fact, the housing opening 2a in question is found on the one hand in the front housing or the front cover 2 and on the other hand as a further housing opening 3a in the rear housing or the rear cover 3, as can be seen by comparing FIGS. 1 and 2. Of course, this applies only by way of example and is in no way restrictive. In any case, the design is thus such that the heat conductor 7 passes through the relevant housing opening 2a, 3a and as a result the heat sink 8 can be arranged in the external region, i.e., it is arranged outside the housing 2, 3. In this external region of the housing 2, 3, the heat sink 8 can particularly effectively dissipate heat to the ambient air by convection, as already described in the introduction.

Since the heat conductor 7 in the exemplary embodiment is designed as a metal pipe and is heat-conductingly and thus also electrically connected to the contact element 4 or the connection piece 5 electrically connected thereto, an electrical insulation 9 is additionally provided, specifically at least in the external region and opposite the heat sink 8 provided there. According to the exemplary embodiment, the electrical insulation 9 is a sheathing of the heat conductor 7 or the metal pipe made of plastics material, which sheathing can be applied to the pipe in question in conjunction with a plastics injection molding process. In any case, the electrical insulation 9 is located in the external region and opposite the heat sink 8 provided there and extends through the housing opening 2a, 3a into the interior of the housing 2, 3. This can be seen in particular from FIG. 2, which shows that the electrical insulation 9 extends several millimeters up to 1 cm or even more into the interior of the housing 2, 3 through the relevant opening 2a, 3a. In this way, the electrical insulation 9 made of plastics material also functions as a seal for the housing opening 2a, 3a, so that the housing 2, 3 is splash-proof.

The electrical insulation 9 is made of a plastics material which has already been referred to and described in the introduction and is therefore electrically insulating and at the same time heat-conducting. For this purpose, the plastics material in question can be equipped with appropriate fillers, which are also described in the introduction. In any case, the electrical insulation 9 as a whole ensures that the heat conductor 7 in question in the external region of the housing 2, 3 does not carry any voltage and that no current can flow through it, but at the same time the required heat conductor is observed starting from the electrical contact element 4 via the heat conductor 7 to the heat sink 8.

It can be seen that the heat conductor 7 is inserted with its one end 7a into the contact element 4 or the associated connection piece 5, namely into a corresponding hollow bore in the connection piece 5 adapted to the heat conductor 7. Inside the housing 2, 3, the heat conductor 7 runs predominantly perpendicular to the longitudinal extension of the contact element 4 and thus also of the connection piece 5. Consequently, the heat conductor 7 in question also has a predominantly perpendicular arrangement compared to the previously described plug-in direction S.

As a result, the heat conductor 7 in the exemplary embodiment according to FIG. 2 is guided in an arc shape into an upper opening 5a of the connection piece 5 of the contact element 4 and dips into this upper opening 5a. Since, according to the exemplary embodiment, both the connection piece 5 and the contact element 4 are each cylindrical, the upper opening 5a in the variant according to FIG. 2 is designed as a half-cylinder opening. Of course, this applies only by way of example and is in no way restrictive.

In the variant according to FIG. 3, the procedure is such that the heat conductor 7 dips predominantly straight into the upper opening 5a, which is also realized in this case, of the connection piece 5 of the contact element 4. The upper opening 5a in question is in this case designed as a cylinder bore or hollow cylinder bore, because the heat conductor 7 according to the exemplary embodiment is tubular or cylindrical. In both cases, the heat conductor 7 is thus thermally coupled to the connection piece 5 and thus to the contact element 4.

In order to increase the heat dissipation of the heat sink 8, said heat sink is equipped with an additional cooling means 10 according to the exemplary embodiment. The cooling means 10 is, for example, a fan 10. The fan 10 may be electrically controlled by a control unit, specifically at least for the period of time while an electrical charging process takes place via the two electrical contact elements 4. In principle, the control unit can operate the cooling means or the fan 10 for a specific and adjustable time even after the charging process in order to avoid any overheating of the heat sink 8 from the outset. For this purpose, the fan 10 or the cooling means 10 is located on the head side of the heat sink 8, so that the air sucked in by the fan 10 flows through individual fins provided inside the heat sink 8 in the longitudinal direction thereof.

### LIST OF REFERENCE SIGNS

charging socket 1
front cover 2
housing opening 2a, 3a
housing 2, 3
front cover 2
rear cover 3
contact element 4
connection piece 5
opening 5a
contact elements 6
heat conductor 7
end 7a
end 7b
heat sink 8
insulation 9
cooling means 10
fan 10
arrow S
plugging direction S

1. A plug connector part for mechanical and electrical connection to a mating plug connector part, in particular a motor-vehicle-side charging socket for coupling to a charging plug as components of an electrical charging infrastructure for electric or hybrid motor vehicles, comprising a housing and at least one electrical contact element located in the housing, and comprising at least one preferably passively cooled heat conductor, one end of which is connected to the contact element and the other end of which has a heat sink,
wherein
the at least one heat conductor extends through a housing opening and is equipped outside the housing with the heat sink arranged there.

2. The plug connector part according to claim 1, wherein the heat conductor has an electrical insulation, in particular outside the housing and opposite the heat sink provided there.

3. The plug connector part according to claim 2, wherein the electrical insulation extends through the housing opening into the interior of the housing.

4. The plug connector part according to claim 1, wherein the heat sink is equipped with an additional cooling means.

5. The plug connector part according to claim 4, wherein the cooling means is designed as, for example, an electrically driven fan.

6. The plug connector part according to claim 1, wherein the heat conductor is designed as a metal pipe, in particular in that the pipe encloses a hermetically sealed volume.

7. The plug connector part according to claim 6, wherein the volume is filled with a working medium for heat transport, for example water or ammonia.

8. The plug connector part according to claim 1, wherein the heat conductor is inserted with its one end into the contact element or a connection piece electrically connected thereto.

9. The plug connector part according to claim 1, wherein the heat conductor runs predominantly perpendicular to the longitudinal extent of the contact element.

10. The plug connector part according to claim 1, wherein the heat conductor dips in an arcuate or predominantly straight manner into an upper opening of the connection piece of the contact element.
